(19) United States
(12) Patent Application Publication
(10) Pub. No.: US 2015/0043610 A1
(43) Pub. Date: Feb. 12, 2015

(54) STRESS DETECTION SYSTEM ON SMALL AREAS AND METHOD THEREOF

(71) Applicant: NATIONAL TSING HUA UNIVERSITY, Hsinchu (TW)

(72) Inventors: Cheng-Yao LO, Hsinchu (TW); Kuan-Hsun LIAO, Hsinchu (TW)

(73) Assignee: NATIONAL TSING HUA UNIVERSITY, Hsinchu (TW)

(21) Appl. No.: 14/084,857

(22) Filed: Nov. 20, 2013

(30) Foreign Application Priority Data
Aug. 6, 2013 (TW) 102128036

(51) Int. Cl. G01N 25/72

(52) U.S. Cl. CPC G01N 25/72
USPC 374/50

(57) ABSTRACT

A system and a method for stress detection on small areas are disclosed. The method is applied to a strain gauge, which uses the Joule heating effect-generated temperature difference to monitor and to localize compressive and tensile strains. Furthermore, the invention provides a systematic extrapolation prediction methodology for strains.

### CROSS REFERENCE

The application claims priority of Taiwan Patent Application NO. 102128036, filed on Aug. 6, 2013, the content thereof is incorporated by reference herein.

### BACKGROUND OF THE INVENTION

1. Field of the invention

The present invention is related to stress detection, and more particularly to a stress detection method and system on small areas by using Joule heating effect-generated temperature difference on the conductive line.

2. Description of Related Art

Surface flatness is a common measurement specification over a wide range of manufacturing industries. Flatness critically affects, for example, the reliability and assembly yield of electronic products and the mechanical fit and functionality of fabricated metal components.

Strain gauges are widely used to evaluate failures or weak points. Because they are invisible, strains must be detected based on physical quantities read out by humans or automatic systems. Light-based optical solutions to strain detection usually take advantages of unique optical effects, such as the Fabry-Perot interference, Moire effect, or the Bragg diffraction, to visualize strain with visible colors or non-visible signals.

The Fabry-Perot interference has one unbiased input light at a specific wavelength, and shows a biased output light at another wavelength if the observing object undergoes constructive or destructive interference. By using the relationship among the thickness of the object, the incident angle, and the wavelength of the input light, users can calculate the thickness of the object by measuring the output wavelength, and then calculate the strain by comparing the thickness before and after change.

The Moire effect strain detection method is used to compare two periodical patterns with the same pattern design. Regardless of how these two patterns overlap with each other, a special Moire pattern appears. However, these two original patterns must be placed close enough to show a Moire pattern. For this methodology to work, one pattern must be attached to the observed object, and the other pattern remains fixed. When the observed object changes its shape or size, the original pattern on the object also changes, producing a different Moire pattern. By comparing the Moire patterns, users can determine the strain of the observed object.

The Bragg diffraction strain detection method observes the reflected light from the observed object, which changes its angle or phase with different material densities. Different optical path lengths represent different material densities, which in turn represent different strains within the material. Thus, measuring the diffraction angle and the phase change of the reflected light can reveal the optical path length change, which in turn reveals the strain change.

Traditional resistive strain gauges monitor the overall resistance, but cannot show where the strain is FIGS. 1(a)-1(b) show that the ideal resistances and their changes are the same if the gauge design and strain conditions are the same. This problem can only be fixed by a sensor array consisting of smaller sensors. Nevertheless, this design increases the complexity of the circuit routing, pattern design, sensing methodology, and analysis algorithm.

In view of the foregoing, a need exists in the art for a system and method for stress detection on small areas. In addition, a need exists for such a system and method to be efficient and cost-effective.

### SUMMARY OF THE INVENTION

The primary objective of the present invention is to provide a method and system for stress detection on small areas.

In order to accomplish the above objective, the method for stress detection on small areas in accordance with the present invention comprises:

providing a substrate having an electrically non-conductive surface material;

depositing at least one conductive line on a selected small area located on the electrically non-conductive surface;

providing electric current to the at least one conductive line for Joule heating effect;

monitoring a heat image showing the Joule heating effect-generated temperature difference on the conductive line; and

analyzing the heat image for localizing compressive and tensile strains on the electrically non-conductive surface.

In a preferred embodiment, the method includes the electric current applied to the at least one conductive line to generate a heat pattern having conductive line image due to the Joule heating, wherein the heat pattern in the image is irregular if the substrate is not flat or cured.

In still another embodiment, the method includes using an infrared receiver to monitor the heat image of conductive line.

Another objective of the present invention is to provide a system for stress detection on small areas in accordance with the present invention, the system comprises: at least one conductive line, formed on an electrically non-conductive surface of a substrate, wherein the at least one conductive line is formed with a layout on a selected small area of the electrically non-conductive surface; a current source, electrically contacting and conducting electric current to the at least one conductive line for Joule heating effect-generated temperature difference on the at least one conductive line; an image acquisition apparatus, disposed above the at least one conductive line and the substrate to capture at least one heat image formed by the electric current passing through the at least one conductive line on the selected small area; and a computer, electrically coupled to the image acquisition apparatus to receive the heat image, and having a program module to read and process the heat image for localizing compressive and tensile strains on the electrically non-conductive surface.

In a preferred embodiment, if the electrically non-conductive surface of the substrate is not flat and the at least one conductive line above the electrically non-conductive surface changes its shape, the resistance along with the at least one conductive line is not equally distributed and the heat pattern in the heat image is irregular.

The conventional resistive technique uses only one physical quantity, and therefore, lacks application flexibility and measurement accuracy. The output signals from a resistive strain gauge only reflect overall performance, and overlook some local details. For example, when an observed surface has one small-value-tension area and another large-value-compression area under the same resistive strain gauge, the monitored resistance returns only a superimposed result of a small-value-compression. This is misleading, and produces unpredictable results. To solve this problem, the invention provides an advanced resistive strain gauge that introduces a second physical quantity of heat to localize the smaller strain quantitatively and qualitatively, and simultaneously provide tunable sensitivity.

Other objects, advantages and features of the present invention will become more apparent upon reading the following non-restrictive description of preferred embodiments thereof, given by way of example only with reference to the accompanying drawings.

### BRIEF DESCRIPTION OF THE DRAWINGS

An embodiment of the invention will now be described, by way of example only, with reference to the accompanying drawings in which:

FIG. 1 is a diagram illustrating the ambiguous judgments from a conventional resistive strain gauge;

FIG. 2 is a flowchart illustrating a method for stress detection on small areas according to the embodiment of the invention;

FIGS. 3 and 4 are schematic view of a system for stress detection on small areas according to the embodiment of the invention;

FIG. 5 is a heat image after the serpentine gold line is applied an electric current according to the embodiment of the invention; and

FIG. 6 shows the heat image while the surface of the substrate has a crease according to the embodiment of the invention.

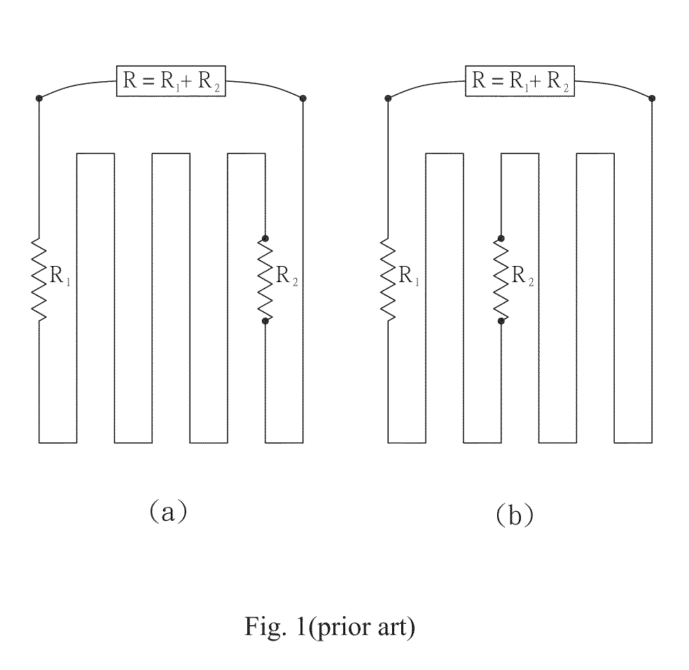

### DETAILED DESCRIPTION OF THE INVENTION

The following description is merely exemplary in nature and is in no way intended to limit the present teachings, applications, or uses. Those of skill in the art will recognize that the following description is merely illustrative of the principles of the invention, which may be applied in various ways to provide many different alternative embodiments.

The invention is applied to a strain gauge, which uses the Joule heating effect-generated temperature difference to monitor and to localize compressive and tensile strains.

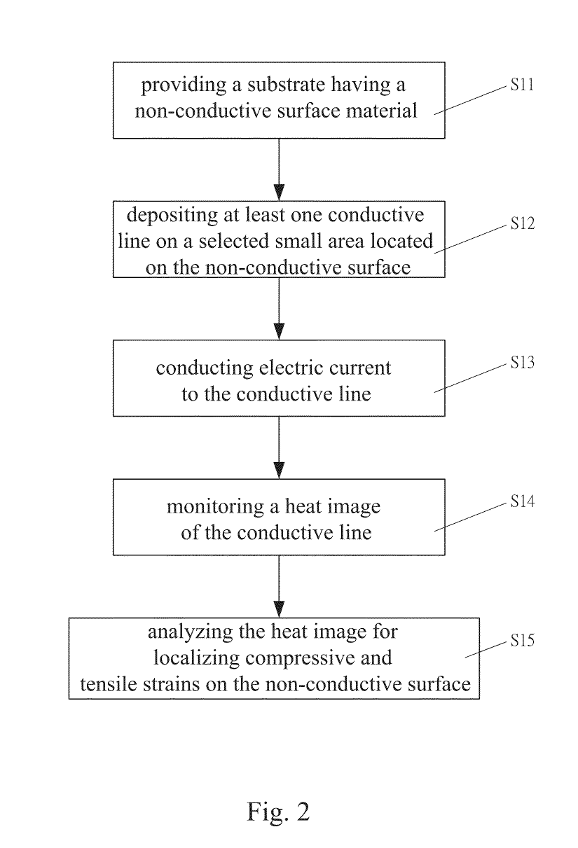

FIG. 2 is a flowchart illustrating a method for stress detection on small areas according to the embodiment of the invention. The method in accordance with the preferred embodiment of the present invention includes the following steps:

Step S11: providing a substrate having an electrically non-conductive surface material, such as semiconductor.

The substrate is a semiconductor substrate or a silicon wafer substrate. In one embodiment the substrate may be a wafer, which is a thin slice of semiconductor material, such as a silicon crystal, used in the fabrication of integrated circuits and other micro devices. Therefore, the surface of the wafer should be flat and smooth to prevent stress and strain during the fabrication of integrated circuits.

Step S12: depositing at least one conductive line on a selected small area located on the electrically non-conductive surface.

The conductive line is a pattern of metal line formed via a semiconductor manufacturing process, such as Photolithography process, and the pattern area of conductive line is about square micrometer. In another embodiment, the conductive line is an alloying metal line.

Step S13: conducting electric current to the conductive line for Joule heating effect.

Step S14: monitoring a heat image showing the Joule heating effect-generated temperature difference on the conductive line.

Step S15: analyzing the heat image for localizing compressive and tensile strains on the electrically non-conductive surface.

The electric current is applied to the conductive line to generate heat pattern having conductive line image because of the Joule heating, if the substrate is curved and the conductive line above it changes its shape, the heat pattern in the image is irregular. During operation, a current or voltage is applied to the metal line, which generates heat because of Joule heating. The thermal energy generated by Joule heating is positively and negatively related to the resistance under a fixed current or voltage, respectively. When the substrate and the metal lines above it change their shapes, the applied current or voltage heats the metal lines accordingly. Thus, users can obtain deformation or strain information by understanding the infrared (IR) emission from the metal lines.

Within the context of the present invention, the term “providing a substrate” or providing an electrically non-conductive surface of such a substrate preferably means modifying the respective surface structure of the substrate such that a micro-structured surface results.

Such a substrate preferably may be any substrate comprising an electrically non-conductive surface or consisting of an electrically non-conductive material. Such a substrate preferably may be any substrate comprising or consisting of an electrically conductive material which has been optionally coated with at least one electrically non-conductive surface or electrically non-conductive material. Such a substrate may be likewise preferably any substrate comprising or consisting of an electrically non-conductive material, which has been optionally coated with at least one layer of the same or a different electrically non-conductive material. According to a specific aspect, the surface of the substrate and the substrate as such (the material, carrying the outer surface or surface coating) may consist of different materials.

Preferably, the electrically non-conductive material or surface of such a substrate comprises or consists of an electrically non-conductive material selected, without being limited thereto, from e.g. any known wafer or silicon crystal, preferably any known electrically non-conductive wafer or wafer substrate, thermoplastic, glass, quartz, sapphire, or any further electrically non-conductive material known to a skilled person.

Further to the electrically conductive line is prepared via a microfabrication process, such as doping or ion implantation, inkjet printing, etching, deposition of various materials, and photolithographic patterning.

Accordingly, an infrared receiver is used to monitor the heat image of conductive lines. The heat image is transferred to a computer to display the image, which shows that the heat pattern is irregular if the substrate is curved and the conductive lines above it changes their shapes.

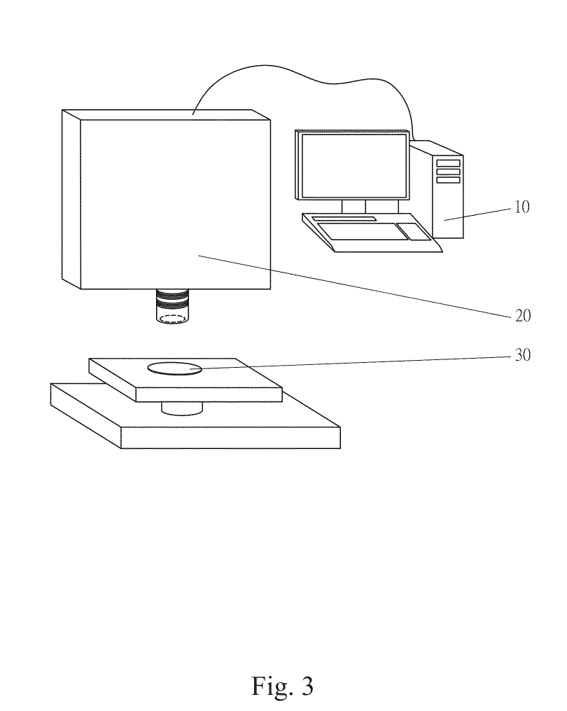

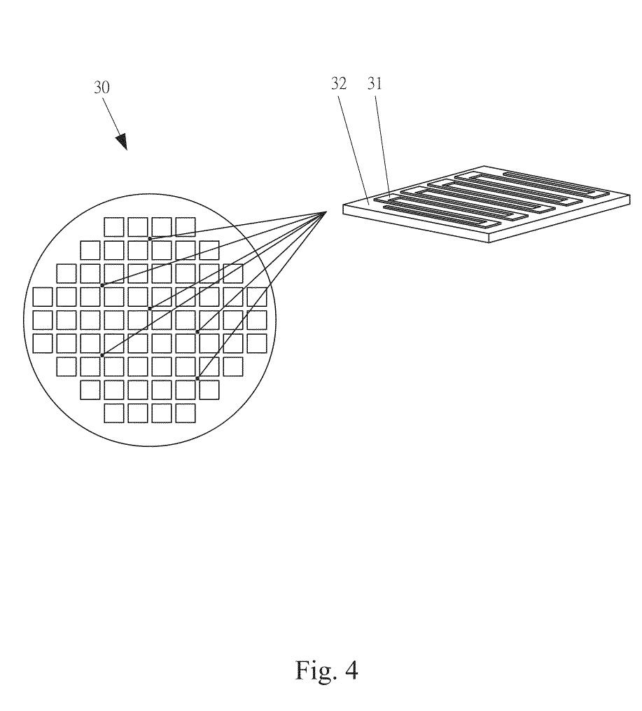

FIG. 3 and FIG. 4 are schematic views of a system for stress detection on small areas according to the embodiment of the invention. The system includes an object 30, an image acquisition apparatus 20, and a computer 10. The object 30 is a substrate having electrically non-conductive material on a surface thereof. In one embodiment the substrate is a semiconductor substrate or a silicon wafer. And a conductive line 31 is formed with a layout on a selected small area (mm) of the surface.

A current source (not shown) electrically conducts electric current to the conductive line 31 for Joule heating effect-generated temperature difference on the conductive line. If the substrate 32 is not flat and the conductive line 31 above it changes its shape, the resistance along with the conductive line 31 is not equally distributed and the heat pattern in the heat image is irregular. An image acquisition apparatus 20 is disposed above the conductive line and the substrate to capture heat images formed by the electric current passing through the conductive line 31 on the selected small area. In one embodiment the image acquisition apparatus 20 is an infrared receiver to monitor the heat image of conductive line 31.

A computer 10 is electrically coupled to the image acquisition apparatus 20 to receive the heat image, and has a program module to read and process the heat image for localizing compressive and tensile strains on the electrically non-conductive surface. The computer 10 can be a conventional personal computer or any data processing machine that includes a process, a memory and input/output ports. The input/output ports may include network connectivity to transfer the images to and from the storing device.

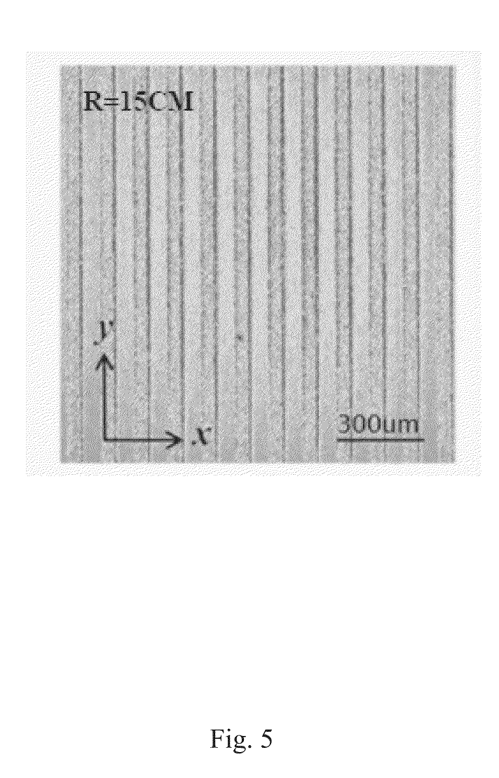

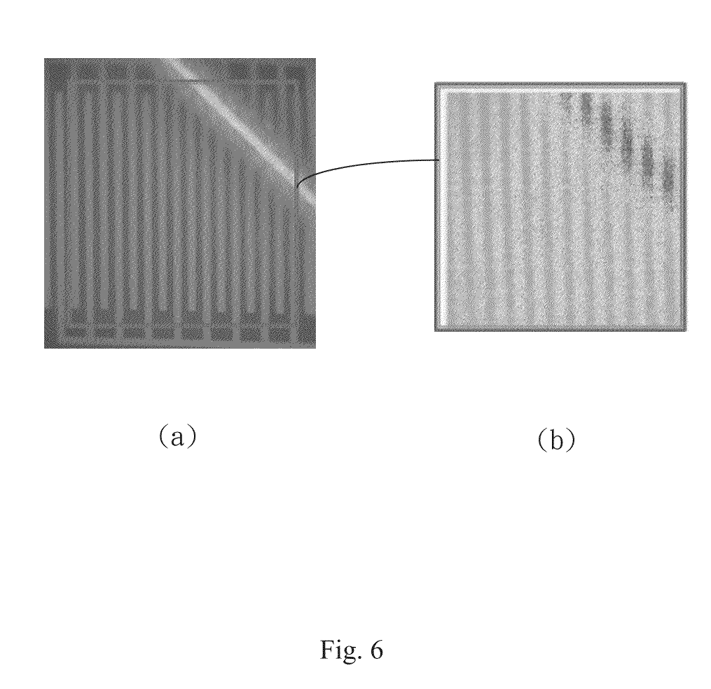

Accordingly, in one embodiment 2 mm×2 mm serpentine gold (Au) line was patterned on a polyethylene naphthalate (PEN) substrate to form a strain gauge shown in FIGS. 5 and 6. This strain gauge was then subjected to either current or voltage to induce the Joule heating effect on the Au line. Because the embodiment requires good heat transfer to reflect the behavior of Joule heating, metals with a large convection heat transfer coefficient (h) should be used. Gold (Au) at a thickness of 10 nm was chosen as the metal material because of its sensitive electrical properties and good thermal conductivity during application and measurement. In another embodiment the metal alloy may be available to form conductive lines.

Referring to FIG. 5, a heat image after the serpentine gold line is applied electric current according to the embodiment of the invention. The PEN substrate has some small areas having flat surfaces without electrical circuit to provide spaces to the gold lines. The electric current is conducted to the conductive line for Joule heating effect. Currents is applied to the Au line to prevent Joule heating from influencing the substrate quality while ensuring that the temperature change is large enough to detect the defects of the surface. FIG. 5 shows the heat image while the surface of the PEN substrate is flat according to the embodiment of the invention.

FIG. 6 shows the heat image while the surface of the PEN substrate has a crease according to the embodiment of the invention. A serpentine gold line was patterned by photolithography on the PEN substrate, with contact pads at both ends of each gold line. The substrate is not flat and the conductive line above it changes its shape and has a crease on the top-right corner (FIG. 6(a)), the resistance along with the conductive line is not equally distributed and the heat pattern in the heat image is irregular (FIG. 6(b)).

By analyzing the heat pattern generated from gold lines supplied with current or voltage, local strain quantitatively and qualitatively of the substrate can be measured. An infrared receiver transfers the captured image to a computer to display the image on the screen easily for human reading. Moreover, the heat pattern can be monitored without close inspection; on-line stress detection on small areas may be performed by monitoring the metal lines from a distance.

Accordingly, in semiconductor fabrication processes after each layer or level was completed, a serpentine gold line may be patterned by photolithography on the surface to monitoring heat image produced by the Joule heating effect-generated temperature difference on the gold line.

From the above description, the invention is applied to a strain gauge, which uses the Joule heating effect-generated temperature difference to monitor and to localize compressive and tensile strains. The invention eliminates the judgment ambiguity from conventional resistive strain gauges where resistance is the only physical quantity to monitor. Furthermore, the invention provides a systematic extrapolation prediction methodology for strains.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for stress detection on small areas, comprising the steps of:
providing a substrate having an electrically non-conductive surface material:
depositing at least one conductive line on a selected small area located on the electrically non-conductive surface;
providing electric current to the at least one conductive line for Joule heating effect;
monitoring a heat image showing the Joule heating effect-generated temperature difference on the conductive line; and
analyzing the heat image for localizing compressive and tensile strains on the electrically non-conductive surface.

2. The method for stress detection on small areas as claimed in claim 1, wherein the substrate is made from a semiconductor substrate, a silicon wafer substrate, an electrically non-conductive crystal, an electrically non-conductive thermoplastic, glass, quartz, sapphire, or an electrically non-conductive mixture of the afore mentioned materials, or comprises an outer surface or surface layer made from such an electrically non-conductive material.

3. The method for stress detection on small areas as claimed in claim 1, wherein the conductive line is a pattern of metal line or alloy line.

4. The method for stress detection on small areas as claimed in claim 3, wherein the conductive line is formed by a semiconductor manufacturing process or microfabrication process selected from doping or ion implantation, inkjet printing, etching, deposition of various materials, and photolithographic patterning, and the pattern area of conductive line is about square micrometer.

5. The method for stress detection on small areas as claimed in claim 1, the analyzing step further including the electric current applied to the at least one conductive line to generate a heat pattern having conductive line image due to the Joule heating, wherein the heat pattern in the image is irregular if the substrate is not flat.

6. The method for stress detection on small areas as claimed in claim 5, further including using an infrared receiver to monitor the heat image of conductive line.

7. A system for stress detection on small areas, which comprising:
at least one conductive line, formed on an electrically non-conductive surface of a substrate, wherein the at least one conductive line is formed with a layout on a selected small area of the electrically non-conductive surface;
a current source conducting electric current to the at least one conductive line for Joule heating effect-generated temperature difference on the conductive line;
an image acquisition apparatus, disposed above the at least one conductive line and the substrate to capture at least one heat image formed by the electric current passing through the at least one conductive line on the selected small area; and
a computer, electrically coupled to the image acquisition apparatus to receive the heat image, and having a program module to read and process the heat image for localizing compressive and tensile strains on the electrically non-conductive surface.

8. The system for stress detection on small areas as claimed in claim 7, wherein the substrate is made from a semiconductor substrate, a silicon wafer substrate, an electrically non-conductive crystal, an electrically non-conductive thermoplastic, glass, quartz, sapphire, or an electrically non-conductive mixture of the afore mentioned materials, or comprises an outer surface or surface layer made from such an electrically non-conductive material.

9. The system for stress detection on small areas as claimed in claim 7, wherein the at least one conductive line is a metal line or an alloy line.

10. The system for stress detection on small areas as claimed in claim 7, wherein if the electrically non-conductive surface of the substrate is not flat and the at least one conductive line above the electrically non-conductive surface changes its shape, resistance along with the at least one conductive line is not equally distributed and the heat pattern in the heat image is irregular.

11. The system for stress detection on small areas as claimed in claim 7, wherein the image acquisition apparatus is an infrared receiver to monitor the heat image of the conductive line.
